(19) United States
(12) Patent Application Publication
(10) Pub. No.: US 2005/0242035 A1
(43) Pub. Date: Nov. 3, 2005

(54) Method for the manufacture of patterned micro-and nanoparticles and use of such particles in the assembly of nanoscale architectures in solution

(75) Inventors: Stephen Gerard Cobbe, Dublin (IE); Donald Joseph Fitzmaurice, Dublin (IE); Loraine Christine Nagle, County Cork (IE); Declan John Ryan, County Kerry (IE)

Correspondence Address: BIRCH STEWART KOLASCH & BIRCH, PO BOX 747, FALLS CHURCH, VA, 22040-0747, US

(73) Assignee: UNIVERSITY COLLEGE DUBLIN, NATIONAL UNIVERSITY OF IRELAND, Dublin (IE)

(21) Appl. No.: 10/524,411

(22) PCT Filed: Aug. 16, 2002
(86) PCT No.: PCT/IE02/00120

§ 371 Date: May 26, 2005

(51) Int. Cl. B05D 1/12; B01D 61/00

(52) U.S. Cl. 210/650; 427/180; 427/203; 427/240; 427/294; 427/205

(57) ABSTRACT

A method for the manufacture of patterned microparticles comprises immobilizing microparticles, including nanoparticles, to be patterned on a surface of a porous membrane, causing an inorganic or organic coating material which can bind to exposed surfaces of said microparticles, and which can permeate through the pores of said membrane, to flow relative to said immobilized microparticles, and removing the microparticles from the membrane following binding of said coating material. The method enables one to prepare a wide range of anisotropically-modified patterned microparticles, including microparticles patterned with nanoparticles or a biomolecular material such as DNA and protein. The patterned microparticles produced can be used in wide range of applications in health, information and communication, and sustainable environment such as shelter, clothing, energy, food, transport and security.

### TECHNICAL FIELD

This invention relates to a method for the manufacture of patterned microparticles, including nanoparticles, more particularly anisotropically patterned micropaiticles and to the use thereof for many different applications, especially where control of such particles is required.

### BACKGROUND ART

The so-called “bottom-up” assembly of functional nanoscale architectures in solution is a goal shared by researchers in many fields (Philp, D., and Stoddart, J. F. Angew. Chem. Int. Ed. Engl. (1996), 35, 1154-1196). Expected benefits of such assembly include greater control over material or device properties and innovative technologies that address unmet needs.

One approach envisaged, is the molecular self-assembly in solution of nanostructures from molecular and condensed phase components (Whitesides, G. M. et al. Science (1991), 254, 1212-1319). Molecular self-assembly is the spontaneous association of molecules under equilibrium conditions into stable, structurally well-defined aggregates joined by noncovalent bonds. Molecular self-assembly is ubiquitous in biological systems and underlies the formation of a wide variety of complex biological structures.

In considering what molecular and condensed phase components might be suitable (Mann, S., et al. Adv. Mater. (2000), 12, 147-150; Niemeyer, C. Angew. Chem. Int. Ed. (2001), 40, 4128), one is immediately attracted to high information content molecules (Lehn, J.-M. Supramolecular Chemistry, Concepts and Perspectives VCH, Weinheim, (1995)) and to the rapidly growing number of nanoparticles whose properties can be tuned by controlling their size and surface composition (Alivisatos, A. P. Science (1996), 271, 933-937).

There exists a growing number of examples where high-infonnation content molecules and nanoparticles have been self-assembled in solution to yield novel nanoscale architectures, some with significant technological potential, including programmed materials synthesis with DNA (Storhoff, J. J. and Mirkin, C. A. Chem. Rev. (1999), 99, 1848-1862).

Despite this progress, it nevertheless remains the case that the structural diversity and functional complexity of the nanoscale architectures that have been self-assembled in solution fall short of what is needed.

Essentially the current state of the art is based on spherical nanoparticles modified by chemisorption of high information content biomolecules. The inherent limitation of these particles is that they are isotropic. As a consequence the nature, rate and extent of recognition directed assembly in solution is the same in all directions. For this reason, the complexity of and function associated with such assemblies is inherently limited.

Efforts directed at preparing patterned nanospheres have included the deposition of a monolayer of gold nanoparticles on one face of a silica nanoparticle using Langmuir-Blodgett techniques (Petit, L. et al. Mater. Lett. (2001), 51, 478). Asymmetric nanoparticles can only be produced with this method on a laboratory scale in common with Langmuir-Blodgett techniques. Other efforts have included the evaporation of a metal onto one face of a latex nanoparticle (Takei, H. and Shimizu, N. Langmuir (1997), 13, 1865). This method is limited in a number of respects. First of all, only part of the method can be carried out in solution, it being necessary to carry out the gold evaporation/chemisorption step in a vapour deposition chamber. Furthermore, it can be difficult to get the coated particles to redisperse into solution. The method is also limited in the nature of coating materials that can be used.

Other methods with similar limitations for the production of asymmetric patterned nanoparticles are known (Himmelhaus, M. and Takei, H. Sens.ActuatorB-Chem. (2000), 63, 24-30; Love, J. C. et al. Nano Lett. (Communication); 2002; ASAP Article; Web Release Date:Jun. 21, 2002);Fugimoto, K. et al. Langmuir (1999), 15, 4630-4635 and Nakahama, K. et al. Langmuir (2000), 16, 7782-7886).

The preparation of patterned nanoparticles to date is limited to the laboratory scale and there is a need for a method which can be carried out on a large- or commercial scale and with which one can use a wide variety of coating materials, especially coating with biological materials.

### DISCLOSURE OF INVENTION

The invention provides a method for the manufacture of patterned microparticles, comprising immobilising microparticles to be patterned on a surface of a porous membrane, causing a coating material which can bind to exposed surfaces of said microparticles, and which can permeate through the pores of said membrane, to flow relative to said immobilised microparticles, and removing the microparticles from the membrane following binding of said coating material.

The method according to the invention can be carried out in solution on a commercial scale and allows for the manufacture of a wide range of patterned microparticles as hereinafter described.

The method according to the invention permits the cost-effective volume-manufacture of patterned microparticles. That is microparticles, especially nanopai-ticles, of one material, which have another material (in the form of smaller nanoparticles or large biomolecules), deposited on a well-defined region of the surface. These patterened nanoparticles can subsequently be modified by adsorption of a monolayer of one or more high-information content molecules or ligands at one or more discrete regions of the surface of the patterned nanoparticle. These adsorbed molecules will cause one or more of these discrete regions to recognise and bind selectively a molecule, a nanoparticle, a substrate or possibly a discrete region on any of the aforementioned thereof.

Preferably, the microparticles are nanoparticles.

According to one embodiment, the immobilised nanoparticles are nanospheres.

The immobilised microparticles are suitably composed of silica or latex.

A suitable size range for silica nanospheres is 0.1 μm-10 μm.

In the case of latex nanospheres a suitable size range is 0.1 μm-10 μm.

Preferably, the surface of the microparticles is chemically modified to facilitate binding of the coating material thereto.

For example, the microparticles can be amine-modified. However, other types of surface modifiers can be used depending on the type of interaction required and the nature of the coating material being used to pattern the microparticles.

The coating material can be composed of nanoparticles.

According to one embodiment, the nanoparticles are inorganic nanoparticles.

For example, the nanoparticles can be gold nanoparticles.

However, other inorganic nanoparticles that can be used include silver nanoparticles and nanoparticles of titanium dioxide (TiO₂) and gallium arsenide (GaAs).

When the nanoparticles are gold nanoparticles and the microparticles are suitably chemically modified, such as when they are amine-modified, then the gold nanoparticles are strongly adsorbed.

However, other inorganic nanoparticles include, for example, semiconductor nanoparticles, insulator nanoparticles and catalytic nanoparticles.

Alternatively, the coating material is comprised of nanoparticles of an organic material.

For example, the coating material can be comprised of nanoparticles of a biomolecular material.

For example, the organic coating material can be composed of a polynucleotide material such as DNA or a polypeptide or protein material.

The microparticles can be coated with an active ingredient for the treatment of human or other animals as hereinafter described.

The coating material can also be comprised of an image contrast material.

A molecular coating material can be mono-, bi- or multifunctional depending on the application to which the patterned nanoparticles are to be put in practice.

The nature of the porous membrane for use in accordance with the invention can also be varied depending on the nature of the microparticles to be patterned and the nature of the coating material.

For example, if the microparticle and/or the coating material has a natural affinity for the material of the membrane, then the desired result may not be achieved or may be impeded.

For example, in the case when one uses amine-modified latex or silica nanospheres and citrate-stabilised gold nanoparticles, together with a relatively low porosity, “track-etch” polymeric (polycarbonate) membrane of the type sold under the trade mark CYCLOPORE by Whatman, and which has randomly distributed cylindrical pores across the membrane surface, it is found that the nanospheres rather than being disposed on the pores as intended also bind to the surface of the membrane which bears a charge.

However, if one uses a membrane of the type sold under the trade mark ANODISC by Whatman, this type of binding is not observed because of the hexagonal arrangement of the pores and also the higher porosity relative to, for example, the aforementioned membrane sold under the trade mark CYCLOPORE. With this type of membrane, it does not matter if the microparticles stick to the surface of the membrane because of the high density of pores and limited amount of surface.

The microparticles should be applied to the membrane in an amount such that there are still some free pores to allow excess coating material to pass through the membrane. This will be readily determined by one skilled in the art.

Thus, in a preferred embodiment, the membrane is a high porosity alumina membrane with the pores arranged in a hexagonal array.

Preferably, the microparticles to be patterned are spin-coated onto the membrane surface.

According to one embodiment, the coating material comes into contact with the immobilised microparticles prior to filtration and excess coating material passes through the pores of the membrane.

Thus, filtration of citrate-stabilised gold nanoparticles through a membrane partially coated with amine-modified silica or latex nanospheres for example promotes preferential binding of gold on one side of the nanospheres to yield dissymmetric nanospheres.

Preferably, a differential pressure is applied to the membrane during said flow of the coating material relative to the immobilised microparticles.

By using differential pressure any adverse effects resulting from mismatch between microparticle size and pore size are diminished.

Further, preferably, a flow rate greater than 1.5 cm³/min is used during filtration of the coating material through said membrane.

In general the optimum conditions for patterning the microparticles can be defined as follows: First of all, the pressure differential should be close to the maximum and, secondly, the probability of sticking of nanoparticles such as gold nanocrystals to micropalticles should be close to 1, i.e. a diffusion-limited regime applies rather than the reaction-limited case. For this purpose the nanospheres in the embodiment described above are modified to provide an amine-terminated surface that provides sufficient affinity for gold nanocrystals during filtration.

In general, a flow rate in the range 2.5-4.5 cm³/min is preferred.

According to an alternative embodiment, the coating material comes into contact with the immobilised microparticles following passage through the pores of the membrane.

In one embodiment the flow of coating material through the membrane is by means of gravity.

In an alternative embodiment, the flow of coating material through the membrane is by means of an electric field.

For example, the membrane can be metallised and serve as a working electrode, the circuit being completed by a counter electrode in the form of a metal grid disposed parallel to the membrane. By varying the direction and magnitude of the applied electric field, the behaviour of the microparticle or coating material can be controlled.

In a still further embodiment, the flow of coating material through the membrane is by means of a magnetic field.

In one embodiment, the mean diameter of the immobilised microparticles exceeds the membrane pore diameter so as to restrict the number of pores in direct contact therewith.

According to a further embodiment, the coated immobilised microparticles are contacted with a solution of a bi-functional molecule which can bind to said coating material so that a number of layers of coating material can be built up on the immobilised microparticles retained on said membrane.

For example, in the case of amine-modified latex or silica nanoparticles and citrate-stabilised gold particles, the coated immobilised nanoparticles can be treated with a dithiol such as 1,8-octanedithiol, the thiol groups of which can bind to the citrate-stabilised gold particles such that a second coating or layer of gold particles can be applied to the coated immiobilised microparticles. This process can be repeated until the desired number of particles have been built up on a given immobilised microparticle as hereinafter described.

Bi-functional nanoparticles provide two spatially distinct sites for modification. A multilayer deposition of gold particles onto thiol-terminated dissymmetric microparticles can result in complete coating of one half of the microparticle. The ionisable amine group on the uncoated half of the microparticle following removal from the membrane can be harnessed, for example, to induce electrophoretic rotation of said particles upon switching of the polarity of an applied electric field.

Once the desired pattern has been achieved, the coated microparticles can be removed from the membrane in a variety of ways, including sonication, dissolution of the membrane, for example using 3MNaOH with an ANODISC membrane, or by reversing the direction of flow.

Accordingly, it will be appreciated that a wide variety of patterned microparticles can be obtained by use of the method according to the invention, including asymmetric/dissymmetric nanocrystal architectures.

It is envisaged that a wide variety of complex nanoscale architectures may be synthesised using different microparticle-surface termini, for example, carboxyl- and cyano termini and different coating materials, for example ferric oxide (Fe₃O₄) and titanium dioxide (TiO₂).

Although anisotropically patterned microparticles are known from the prior art as described above, they have not been produced in a manner which can be carried out on a large or commercial scale.

Anisotropically, biologically patterned microparticles have not been previously manufactured.

Thus, the invention provides an anisotropically, biologically modified patterned microparticle.

The invention also provides an anisotropically, biologically modified patterned nanoparticle.

The invention further provides a nanostructure assembled on an anisotropically, biologically modified patterned particle as hereinbefore defined.

For example, the nanostructure can be a nanowire.

Thus, using the method according to the invention one can prepare a family of derived nanostructured materials which include the following: Aggregates of patterned or targeted patterned nanoparticles; nanostructured films prepared from patterned or targeted patterned nanoparticles; and nanocomposites prepared from conventional materials and patterned or targeted nanoparticles or any other such derived nanostructured material. The subsequent processing, for example thermal, microwave or laser processing, of these materials may yield additional derived nanostructured or conventional (the nanostructured material being lost in processing) materials.

The patterned or targeted patterned nanoparticles described above (hereinafter referred to in the following list of applications as the patterned and targeted patterned nanoparticles) can be used in any application where the fact that the nanoparticles have been patterned and possibly targeted endows them with properties that enable new or improved applications.

The derived nanostructured nanomaterials can be used in any application where the fact that they are in part or in whole constituted fiom patterned or targeted patterned nanoparticles endows them with properties that enable new or improved applications.

New or improved applications include applications in health, information and communication, and sustainable environment such as shelter, clothing, energy, food, transport and security.

In healthcare the following applications can be foreseen:
Genomics
The patterned and targeted patterned nanoparticles may be used as labels in high-throughput or other screening processes. The inherent advantage offered by these particles being that one region can be optimised to recognise and bind a specific sequence of bases or base-pairs, while another region can be optimised for another recognition-binding event, for promoting a chemical modification of the bound sequence, or for reporting a recognition-binding or a chemical modification event.
Proteomics
In the case of proteomics, the situation is essentially the same as for genomics set out above, but applied to amino acid sequences.
Drug Discovery
The patterned nanoparticles may be used to dispense reactants in high-throughput or other screening processes. The inherent advantage offered by patterned nanoparticles is that they can be used to dispense in to well-plated devices small quantities of two or more reactants for dissolution and subsequent reaction. Alternatively, the patterned nanoparticles may be modified by adsorbed catalysts or labels that can promote or report on the reaction in question.
Drug Delivery
The patterned and targeted patterned nanoparticles may be used to deliver drugs, particularly poorly soluble drugs, to the intended site of action within a patient. The inherent advantage offered by patterned nanoparticles is that two or more drugs may be targeted to one site. This approach may be extended to the delivery of combinations of drugs, co-factors and labels. Furthermore, better control over the rate of dissolution of these constituent components will be possible, as compared with particles in which such components are simply mixed.
Diagnostics
The patterned and targeted patterned nanoparticles may be used as markers in a range of diagnostics test formats. The inherent advantage is that they may be bound with different orientations to a substrate depending on whether a disease state is indicated or not. Depending on the structure of the patterned nanoparticle in question, this may report a different signal. Furthermore, as in the case for drug discovery and drug delivery described above, the binding-recognition regions and the reporting-signalling regions of these particles may be separately optimised in respect of their intended function (as opposed to mixed particles).
Sensors
The patterned or targeted patterned nanoparticles offer the inherent advantage that they may be adsorbed with a particular orientation at a substrate. Depending on the orientation, it may be possible to sense an increase in current, voltage or other measurable signal. For example, semiconductor particles patterned with a sensitiser and adsorbed with a specific orientation may lead to an increase in the measured photovoltage/photocurrent. Insulator particles patterned with a metal and adsorbed with a specific orientation may lead to a increase in resistance or increase in current.
Biocompatable Coatings
The patterned and targeted patterned nanoparticles may be used to produce biocompatable coatings. The inherent advantage of these particles being that one of the patterned regions may be optimised to bind to an implant. The other patterned region may be optimised to inhibit/promote binding at a biological interface.
Vitamins and Nutriceuticals
The patterned and targeted patterned nanoparticles may be used to produce improved nutriceutical products by patterning existing nanoparticle constituents found in many food-stuffs with one or more nutritional supplements such as vitamins.
Cosmetics and Cosmeceuticals
Many cosmetic products are formulated using nanoparticles. The patterned and targeted patterned nanoparticles offer the prospect of improved cosmetics. For example, it will be possible to manufacture nanoparticles of silica patterned with a dye, which combine the roles of both filler and a colorant. Many other related examples may be envisaged. It will also be possible to orient targeted patterned nanoparticles at the skin-air interface, with one surface optimised for interaction with the skin for example, for reasons of adhesion or texture and the other optimised for the air interface for example, for reasons of colour or solar screening.
The availability of patterned and targeted patterned nanoparticles also offers the prospect of improved cosmeceuticals, where the nanoparticles used to formulate the nanoparticles are patterned with a pharmaceutically active compound (or the converse).

In information and communication the following applications can also be foreseen as follows:
Interconnects and Active and Passive Electronic and Photonic Components
While these emerging fields are still at a very early stage, it is clear that their future development will be linked to the availability of patterned and targeted nanoparticles and derived nanostructured materials that can be easily and cost-effectively manufactured. The advantages offered by these materials are their diversity of structure and associated function and their ease and cost-effectiveness of manufacture.
High-density Magnetic and Optical Storage Media
The patterned and targeted patterned nanoparticles and derived novel nanostructured materials may all find applications in established and emerging storage technologies. Patterned and targeted patterned nanoparticles of a magnetic material may be deposited on a suitable substrate. The inherent advantage offered by these nanoparticles is that they can be orientated at the substrate and simultaneously optimised for interaction with the substrate and the read-write head. Other proposed approaches would include the thermal processing of patterned nanoparticles to produce alloys possessing enhanced properties.
The patterned and targeted patterned nanoparticles may also be used to prepare novel and improved optical storage media. Again the inherent advantage offered by these nanoparticles is that they can be orientated at the substrate and simultaneously optimised for interaction with the substrate and the read-write head.
Batteries
The patterned and targeted patterned nanoparticles and derived novel nanostructured materials may all find applications in established and emerging batteries technologies. Patterned nanoparticles, in particular, will find applications in plastics-based battery technologies. Their inherent advantage will be the ease with which they can be manufactured and the diversity of patterned nanoparticle architectures which may be manufactured. One such embodiment is a material in the form of nanoparticles, suitable for charge storage, patterned by deposition of conducting binder. This will serve to produce a structure through which charge may be transported, but which is also flexible and can be deposited on plastics substrates. Targeted patterned nanoparticles may also be used to optimise, through desirable recognition-binding events, the organisation of the patterned nanoparticles.
Displays including ‘Smart Windows’
The patterned and targeted patterned nanoparticles and derived novel nanostructured materials may all find applications in established and emerging display technologies. Patterned nanoparticles, in particular, will find applications in display technologies, which rely on rotating or transporting patterned nanoparticles in an applied electric or magnetic field. Their inherent advantage will be the ease with which they can be manufactured and the diversity of specific embodiments, which may be manufactured. They will also find applications in electrochromic displays (and windows), which are based on nanostructured films prepared fiom nanoparticles modified by adsorption of a redox chromophore or other functional component.
Sensors
In the case of sensors the general principles that will apply correspond to those set out above for healthcare applications. These sensors will be used to provide inputs to information processing systems. Such sensors will include those used to monitor and control the built and natural environments, manufacturing and quality-control processes and the access of individuals to real and virtual spaces.
   Sustainable Environment
Shelter
The patterned and targeted patterned nanopaiticles and derived novel nanostructured materials may be used to produce next-generation-building materials. Their inherent advantages are that they are characterised by high information content/functionality and low embodied energy; also that they may be cost-effectively manufactured at volume. An example of such a material might include a coating for a ceramic tile, which prevents both fungal and bacterial growth by combining the anti-bacterial function of a metal oxide nanoparticle with the anti-fungal activity of a deposited inorganic coating. The same approach can be adapted for producing high surface area materials that can be used to purify and remediate the air and water flows in and out of a building.
Energy-Environment
The patterned and targeted patterned nanoparticles and derived novel nanostructured materials may all find applications in established and emerging solar cell technologies. Their inherent advantage will be the ease with which they can be manufactured and the diversity of patterned nanoparticle architectures, which may be manufactured. One such embodiment is a material in the form of nanoparticles, suitable for charge separation, patterned by deposition of sensitiser. This will serve to produce a structure through which one can both harvest photons and separate charge. Targeted patterned nanoparticles may also be used to optimise, through desirable recognition-binding events, the organisation of the patterned nanoparticles.
Food
Many foods contain additives, which are present as nano- or microparticles. The ability to pattern and target these particles offers the prospect of highly functional additives. These highly functional additives would combine the functions of any or all of the following: Security, tracibility, colour, aroma, texture, flavour and preservation. Clearly these applications overlap with those set out above in the areas of nutriceuticals and cosmeticeuticals.
Transport
The patterned and targeted nanoparticles and derived nanostructured nanomaterials will find applications as fuel additives and catalytic converters. In the case of fuel additives they may be formulated to contain components that both increase efficiency and reduce unwanted emissions. In the case of catalytic converters, a derived nanostructured film may be comprised of nanoparticles that act as a support and are coated with a suitable catalyst. These advantages are enhanced by the fact that these materials can be cost-effectively manufactured at volume.
Security
The principal security applications for patterned and targeted patterned nanoparticles and derived nanostructured materials will include those currently based on conventional nanoparticles and derived materials and those that will emerge. The inherent advantage offered by these materials is that they contain more information. For example as nanoparticles are more widely used as security markers, the need to prevent the counterfeiting of these markers will also increase. One approach will be to pattern the nanoparticles. Patterning these nanoparticles will also permit additional information to be stored thereon. These advantages are enhanced by the fact that these materials can be cost-effectively manufactured at volume.

### BRIEF DESCRIPTION OF THE DRAWINGS

FIG. 1. is a schematic representation of a first embodiment of the method according to the invention;

FIG. 2 is a scanning electron micrograph of silica nanospheres (200 nm) retained on a membrane filter as described in Example 1;

FIG. 3 is a transmission electron micrograph of the silica nanospheres of FIG. 2 patterned by deposition of gold nanoparticles (16 nm) as described in Example 1;

FIG. 4 is a scanning electron micrograph of latex nanospheres (490 nm) retained on a membrane filter (0.2 μm) as described in Example 2;

FIG. 5 is a transmission electron micrograph of the nanospheres of FIG. 4 patterned by deposition of gold particles (16 nm) as described in Example 2;

FIG. 6 is a transmission electron micrograph of a nanowire on patterned silica nanospheres as described in Example 3;

FIG. 7 is a transmission electron micrograph of a nanowire on patterned latex nanospheres as described in Example 3;

FIG. 8 is a schematic representation of a second embodiment of the method according to the invention;

FIG. 9 is a transmission electron micrograph of nanospheres patterned upon attachment of a single gold nanoparticle (16 nm) as described in Example 4;

FIG. 10 is a transmission electron micrograph which depicts the assembly of a nanowire on patterned silica nanospheres in two layers as described in Example 4; and

FIG. 11 is a transmission electron micrograph which depicts the assembly of a nanowire on patterned silica nanospheres in five layers as described in Example 4.

### MODES FOR CARRYING OUT THE INVENTION

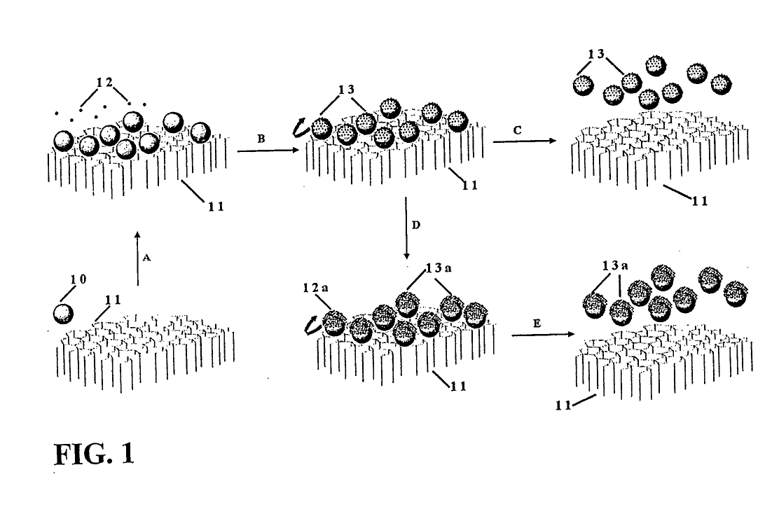

A schematic representation of a first embodiment according to the invention is set out in FIG. 1:

Nanospheres 10 are spin-coated onto a membrane filter 11 (A). A nanoparticle dispersion 12 is filtered through the membrane 11 on which the nanospheres 10 are retained (B). The patterned nanospheres 13 are redispersed in a suitable solvent by sonicating the membrane filter 11 (C). Alternatively, a solution of a bifunctional molecule (not shown), followed by a dispersion of nanoparticles 12a, may be filtered though the membrane 11 on which the patterned nanospheres 13a are retained (D). The last two steps may be repeated until the patterned nanospheres 13a are redispersed by sonicating the membrane filter 11 (E).

### EXAMPLE 1

An aqueous dispersion of citrate-stabilised gold nanoparticles (16 nm diameter) was prepared using the procedure developed by Frens (Frens, G; Nature Phy. Sci., (1973), 241, 20-22). Silica nanoparticles (200 nm diameter) were prepared using the procedure developed by Stober and Fink (Stober, W., and Fink, A., J Colloid Interface Sci., (1968), 26, 62-69) and surface-modified with 3-aminopropyltriethoxysilane using the procedure developed by van Blaaderen and Vrij (van Blaaderen, A., and Vrij, A., J Colloid Interface Sci. (1993), 156, 1-18). In the course of their preparation and subsequent surface-modification, multiple centrifugation (Sorvall Instruments, A500 rotor) and washing (ethanol, 50 mL) cycles were employed to ensure sample purity.

A membrane filter (0.2 μm ANODISC® from Whatman) was mounted on a spin-coater (Model KW-4B from Chemat Technology) and held in place using adhesive tape. An ethanolic dispersion of amine-modified silica nanospheres (100 μL, 3.83×10¹⁴ nanospheres dm⁻³) was spin coated onto the membrane filter (40 s, 600 rpm). Scanning electron micrographs (SEMs) of these membranes were obtained using a JEOL SEM 35C (at an acceleration voltage of 15 kV) for a gold-coated (30 nm thickness) sample mounted directly onto conducting stubs using conducting tape as adhesive.

The membrane filter was removed and inserted into a membrane filter vacuum apparatus (Model FG25 from Whatman). An aqueous dispersion of citrate-stabilised gold nanocrystals (10 mL, 1.35×10¹⁴ nanoparticles dm^{31 3}) was filtered through the membrane. A pale red colour developed at the membrane surface. It should be noted, that in the case of unmodified silica nanospheres no red colour develops at the membrane surface. This finding confirms that amine modification of the silica nanospheres is essential to ensure the gold nanoparticles are adsorbed at the exposed face under the conditions described herein.

To redisperse the patterned silica nanospheres, the membrane filter was removed from the filtration apparatus and sonicated in ethanol (5 mL, 15 min). The red coloration of the membrane was transferred to the solution. The membrane was removed from the resulting dispersion, which was used to prepare samples for analysis by transmission electron microscopy (TEM). All TEMs were obtained using a JEOL 2000 FX TEMscan (at an acceleration voltage of 80 kV) for samples deposited on carbon-coated copper grids.

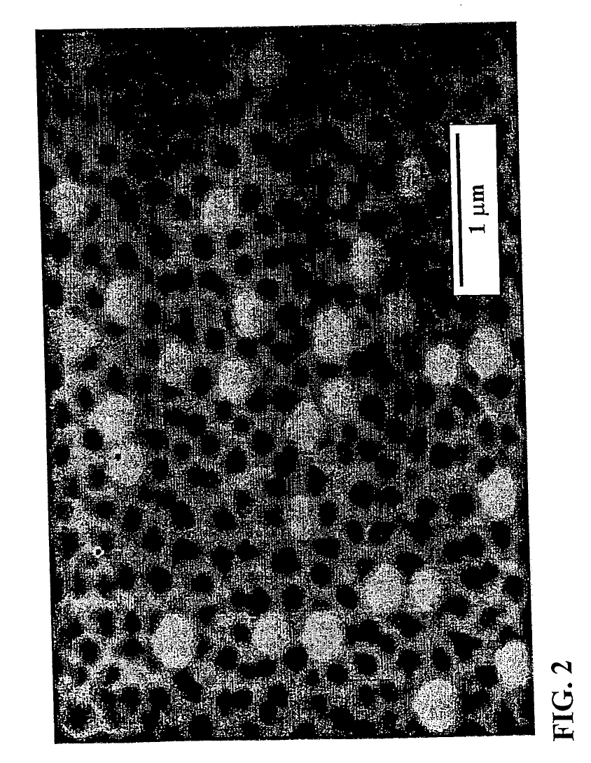

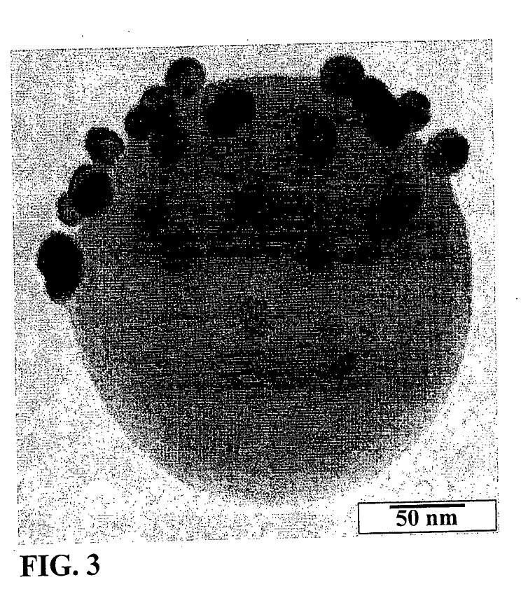

The amine-modified silica nanospheres retained on a membrane filter are shown in FIG. 2. The patterned silica nanospheres obtained by filtering the aqueous dispersion of citrate-stabilised gold nanoparticles through the same membrane are shown in FIG. 3. It is clear from FIG. 3 that gold nanoparticles are adsorbed only on one face of the silica nanospheres.

### EXAMPLE 2

Amine-modified latex spheres (490 nm diameter) were used as supplied (Sigma-Aldrich). An aqueous dispersion of these nanospheres (100 μL, 3.83×10¹⁴ nanospheres dm⁻³) was spin-coated onto the membrane filter (40 s, 600 rpm). The membrane filter was removed and inserted into the membrane filtration apparatus and exposed, as described above, to a dispersion of citrate-stabilised gold nanoparticles (10 mL, 6.1×10¹⁴ nanoparticles dm⁻³). To redisperse the patterned latex nanospheres, the membrane filter was removed from the filtration apparatus and sonicated in water (5 mL, 15 min).

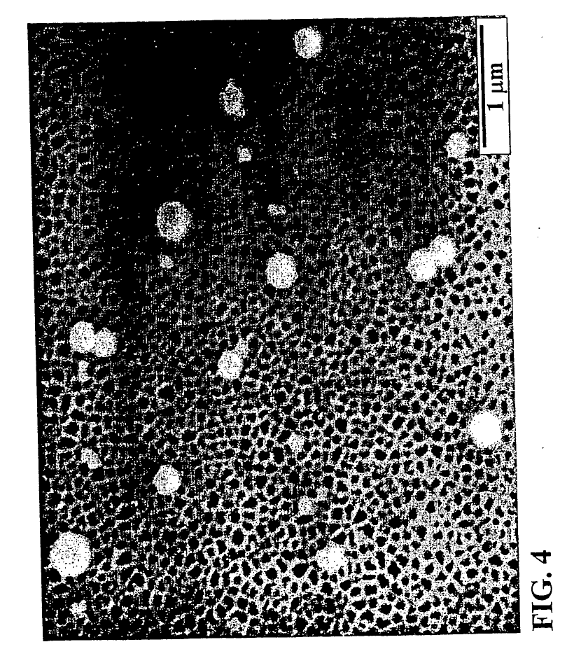

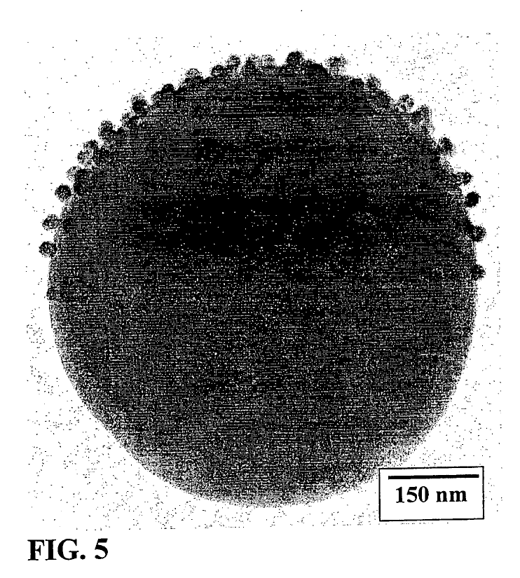

The amine-modified latex nanospheres retained on the membrane filter are shown in FIG. 4. The patterned latex nanospheres obtained by filtering an aqueous dispersion of citrate-stabilised gold nanoparticles through the above membrane are shown in FIG. 5. As in the case of Example 1, it is clear that gold nanoparticles are adsorbed only on one face of the latex nanospheres.

The strategy presented in Examples 1 and 2 for patterning nanospheres is based on ultra-filtration technology. The strategy relies on retaining the nanospheres to be patterned at the surface of a membrane filter. Careful control of the number of retained nanospheres is required to ensure a sufficient number of unblocked pores. This is important as it ensures that filtration of the nanoparticles can occur under the maximum pressure differential possible.

### EXAMPLE 3

It is possible to deposit nanoparticles only on one face of a nanosphere using the approach described in Examples 1 and 2. It is also possible to extend this approach as follows and as depicted in FIG. 1: By exposing the nanoparticles deposited only on one face of the nanospheres retained on the membrane, first to a solution of a bifunctional molecule and second to a dispersion of nanoparticles. Repeating these two steps will deposit the required number of layers of nanoparticles on the originally deposited nanoparticle layer. As before, the patterned nanoparticles are redispersed by sonicating the membrane filter.

In practice a solution of 1,8-octanedithiol in ethanol (10 mL, 0.1 nmol dm⁻³) was filtered through the membrane retaining patterned silica or latex nanospheres, which were then washed using copious amounts of ethanol. Gold nanocrystals were then filtered through the membrane filter as described in Examples 1 and 2. These two-steps were repeated until the required number of nanoparticle layers had been deposited. Finally, the resulting assembly was passivated by filtering a solution of a butane thiol in ethanol (10 mL, 0.1 nmol dm⁻³). Following sonication of the membrane filter, a TEM sample was prepared from the resulting dispersion.

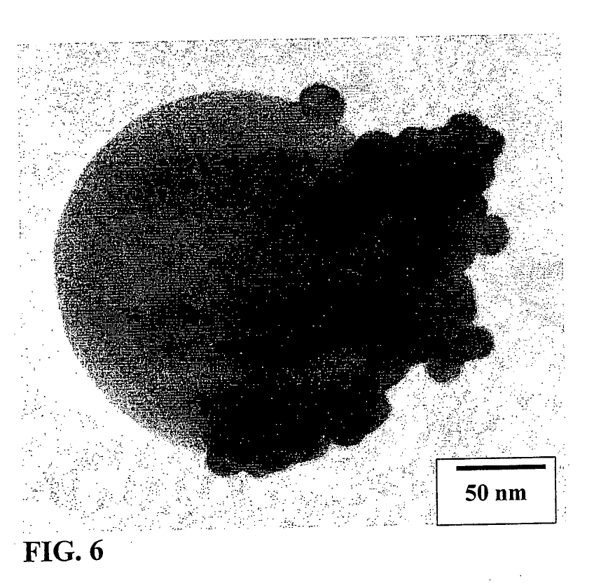

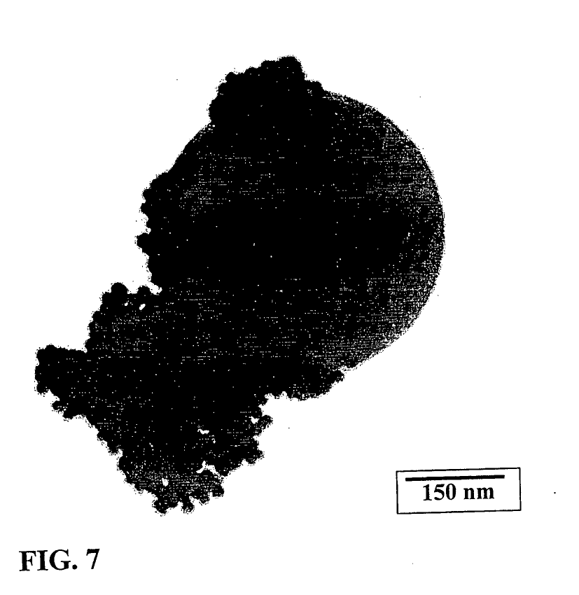

As will be observed in FIGS. 6 and 7, this aspect of the method according to the current results in the templated assembly of a nanoscale architecture consisting of a single gold nanowire attached to the face of silica or latex nanosphere, previously patterned by deposition of a layer of gold nanoparticles.

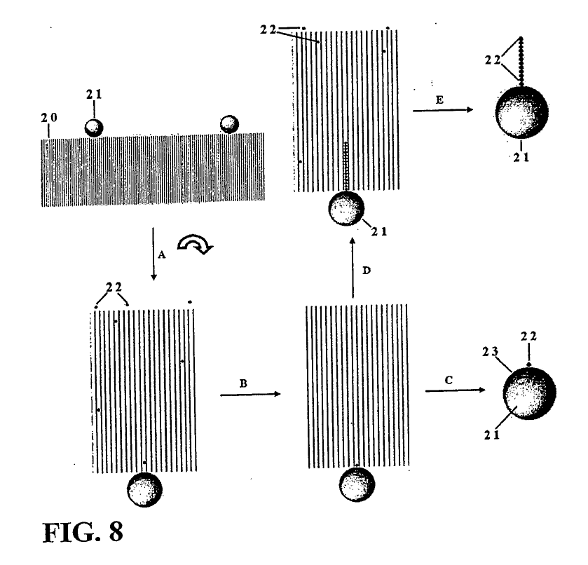

FIG. 8 is a schematic representation of a second embodiment of the method according to the invention:

A membrane filter 20(cross sectional view) is inverted so as to sandwich retained nanospheres 21 between it and the sintered glass support (A). A nanoparticle 22 dispersion is filtered through the underside of the membrane 20 (B). The patterned nanospheres 23 are redispersed in a suitable solvent by sonicating the membrane filter 20 (C). Alternatively, a solution of a bifunctional molecule, followed by a dispersion of nanoparticles 22, may be filtered though the underside of the membrane (D). The last two steps may be repeated until the patterned nanospheres are redispersed by sonicating the membrane filter 20 (E).

### EXAMPLE 4

The strategy presented in this Example for patterning nanospheres is based on ultra-filtration technology. The nanospheres to be patterned are immobilised on the upper surface of a membrane filter which is subsequently inverted before insertion in the membrane filter vacuum apparatus. Careful control of the number of retained nanospheres is required to ensure a sufficient number of unblocked pores. This is important as it ensures that filtration of the coating nanoparticles can occur under the maximum pressure differential possible. Key to effecting the deposition of just one nanoparticle on each nariosphere is the choice of membrane pore-, nanoparticle- and nanosphere diameter as well as the nanoparticle concentration filtered.

First of all, by filtering a sufficiently dilute solution of nanoparticles through the membrane, widespread deposition on the nanosphere is disfavoured.

Secondly, the diameter of the nanosphere to be patterned is chosen to greatly exceed the membrane pore diameter thus restricting the number of pores in direct contact with the nanosphere surface to one (or few).

Thirdly, the diameter of the membrane pore is selected to slightly exceed (by ca. 25%) the nanoparticle diameter, thereby mediating the delivery of a single nanoparticle to the contacting nanosphere surface.

In practice an aqueous dispersion of citrate-stabilised gold nanoparticles (16 nm diameter) was prepared using the procedure developed by Frens (Frens, G (1973) supra). Silica nanoparticles (150 nm diameter) were prepared using the procedure developed by Stober and Fink (Stober, N. and Fink, A (1968), supra) and surface-modified with 3-aminopropyl-triethoxysilane using the procedure developed by van Blaaderen and Vrij (van Blaaderen, A. and Vrij, A., (1993) supra). In the course of their preparation and subsequent surface-modification, multiple centrifugation (Sorvall Instruments, A500 rotor) and washing (ethanol, 50 mL) cycles were employed to ensure sample purity.

A membrane filter (0.02 μm ANODISC® from Whatman) was mounted on a spin-coater (Model KW-4B from Chemat Technology) and held in place using adhesive tape. An ethanolic dispersion of amine-modified silica nanospheres (100 μL, 1.03×10¹⁴ nanospheres dm⁻³) was spin-coated onto the membrane filter (40 s, 600 rpm). Scanning electron micrographs (SEMs) of these membranes were obtained using a JEOL SEM 35C (at an acceleration voltage of 15 kV) for a gold-coated (30 nm thickness) sample mounted directly onto conducting stubs using conducting tape as adhesive.

The membrane filter was removed and inverted prior to insertion into a membrane filter vacuum apparatus (Model FG25 from Whatman) thereby sandwiching the immobilised nanospheres between it and the sintered glass support. An aqueous dispersion of citrate-stabilised gold nanocrystals (10 mL, 6.75×10¹¹ nanoparticles dm⁻³) was filtered through the membrane. A faint pink tinge developed at the membrane surface. It should be noted, that in the case of unmodified silica nanospheres no colouration of the membrane was observed. This finding confirms that amine modification of the silica nanospheres is required to ensure that the gold nanoparticles are adsorbed at the exposed face under the conditions described herein.

Copious amounts of ethanol were flushed through the membrane's upper and under surface eliminating surplus nanoparticles that may have become trapped in the nanosphere-plugged channels.

To redisperse the patterned silica nanospheres, the membrane filter was removed from the filtration apparatus and sonicated in ethanol (5 mL, 15 min). The membrane was removed from the resulting dispersion, which was used to prepare samples for analysis by transmission electron microscopy (TEM). All TEMs were obtained using a JEOL 2000 FX TEMscan (at an acceleration voltage of 80 kV) for samples deposited on carbon-coated copper grids.

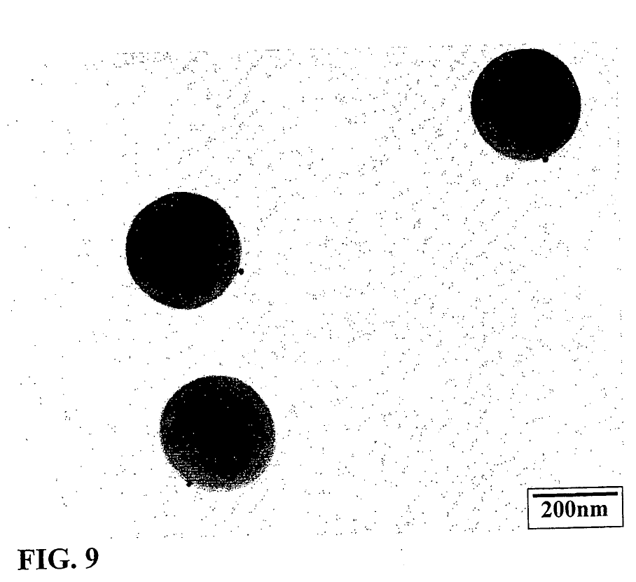

The amine-modified silica nanospheres retained on the membrane filter appear as in the case of FIG. 2 described in Example 1. The patterned silica nanospheres obtained by filtering the aqueous dispersion of citrate-stabilised gold nanoparticles through the underside of the same membrane are shown in FIG. 9. It is clear from FIG. 9 that each silica nanosphere is decorated with a single gold nanoparticle.

### EXAMPLE 5

It is possible to deposit a single nanoparticle on a nanosphere using the approach described in Example 4. It is also possible to extend this approach as depicted in FIG. 8 as follows: By exposing the nanoparticle deposited on the nanosphere retained on the membrane, first to a solution of a bifunctional molecule and second to a dispersion of nanoparticles. Repeating these two steps will deposit the required number of layers of nanoparticles on the originally deposited nanoparticle layer. As before, the patterned nanoparticles are redispersed by sonicating the membrane filter.

In practice a solution of 1,8-octanedithiol in ethanol (10 mL, 10 μmol dm⁻³) was filtered through the underside of the membrane retaining patterned silica nanospheres, which were then washed using copious amounts of ethanol. Gold nanocrystals were then filtered through the membrane filter as described in previous Examples. These two-steps were repeated until the required number of nanoparticle layers had been deposited. Finally, the resulting assembly was passivated by filtering a solution of a butane thiol in ethanol (10 mL, 10 μmol dm⁻³). Following sonication of the membrane filter, a TEM sample was prepared from the resulting dispersion.

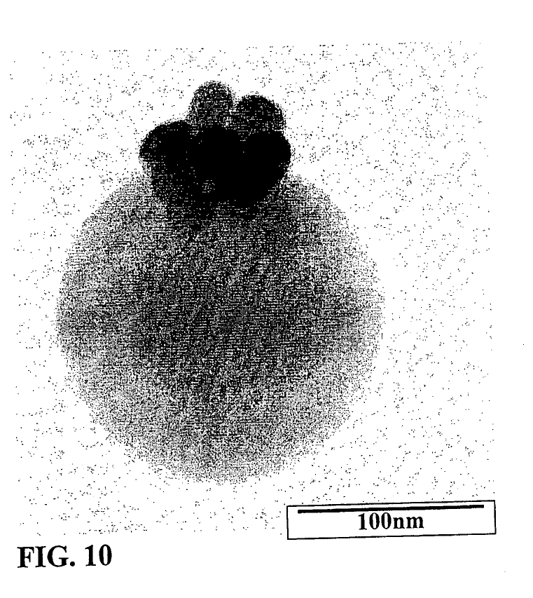

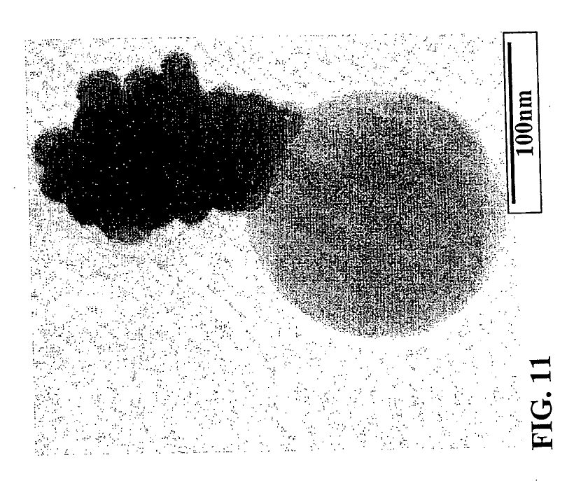

As may be seen (FIGS. 10 and 11), this aspect of the method according to the invention results in the templated assembly of a nanoscale architecture consisting of a single gold nanowire attached to the face of a silica nanosphere, previously patterned by deposition of a single gold nanoparticle.

An alternative approach that may be taken is to chemically reduce (electroless deposition) a gold salt on the patterned nanosphere forming a continuous gold nanowire.

### EXAMPLE 6

Silica nanospheres, 180 nm in diameter, were synthesised according to methods originally developed by Stöber et al. (Stober et al. (1968) supra). They were subsequently modified using 3-aminopropyl-dimethylethoxysilane as a silane-coupling agent following the strategy developed by van Blaaderen and Vrij (van Blaaderen et al. (1993) supra). The aminopropyl functionalized silica nanospheres were further modified by biotinylating the amino functionality. Specifically, to a dispersion of amine-modified silica (5 mL, 2.42×10¹⁵ M nanospheres, 7×10⁻⁴ M NH_{2(surface)}) in anhydrous DMF was added biotin (0.085 g, 3.5×10⁻⁴ mol) and 1-ethyl-3-(3-dimethylaminopropyl)carbodiimide (EDAC) (0.075 g, 3.5×10⁻⁴ mol) and the mixture was stirred for 24 h at ambient temperature. The dispersion was then centrifuged (3000 rpm, 5 minutes; Sorvall Instruments RT6000B using A500 rotor) and sonicated (Ultrawave, 15 minutes) consecutively from alternating MeOH (50 mL) and CHCl₃ (50 mL) washing solvents five times. They were finally dissolved in EtOH.

A dispersion of the biotinylated spheres in EtOH (100 μL, 3.83×10 ¹⁴ nanospheres dm⁻³) was spin-coated onto the membrane filter (40 s, 600 rpm). The membrane filter was removed and inserted into the membrane filtration apparatus and exposed to, as described above, initially a solution of citrate buffer, followed by a streptavidin solution (5 mL, 3.5×10⁻⁵ mol). It was then flushed with citrate buffer again. Finally it was flushed with a dispersion of citrate-stabilised DSDA (disulphide desthiobiotin analogue) modified gold nanopaiticles (10 mL, 1.2×10¹⁵ nanoparticles dm⁻³). The membrane filter was removed from the filtration apparatus and sonicated in water (5 mL, 15 min).

1. A method for the manufacture of patterned microparticles, comprising immobilising microparticles to be patterned on a surface of a porous membrane, causing a coating material which can bind to exposed surfaces of said microparticles, and which can permeate through the pores of said membrane, to flow relative to said immobilised microparticles, and removing the microparticles from the membrane following binding of said coating material.

2. A method according to claim 1, wherein the microparticles are nanoparticles.

3. A method according to claim 2, wherein the immobilised nanoparticles are nanospheres.

4. A method according to claim 1, wherein the microparticles are composed of silica or latex.

5. A method according to claim 1, wherein the surface of the microparticles is chemically modified to facilitate binding of the coating material thereto.

6. A method according to claim 1, wherein the coating material is composed of nanoparticles.

7. A method according to claim 6, wherein the nanoparticles are inorganic nanoparticles.

8. A method according to claim 7, wherein the nanoparticles are gold nanoparticles.

9. A method according to claim 8, wherein the gold nanoparticles are citrate-stabilised gold nanoparticles.

10. A method according to claim 1, wherein the coating material is comprised of nanoparticles of an organic material.

11. A method according to claim 10, wherein the coating material is comprised of nanoparticles of a biomolecular material.

12. A method according to claim 1, wherein the membrane is a high porosity alumina membrane with the pores arranged in a hexagonal array.

13. A method according to claim 1, wherein the microparticles to be patterned are spin-coated onto the membrane surface.

14. A method according to claim 1, wherein the coating material comes into contact with the immobilised microparticles prior to filtration and excess coating material passes through the pores of the membrane.

15. A method according to claim 14, wherein a differential pressure is applied to the membrane during said flow of the coating material relative to the immobilised microparticles.

16. A method according to claim 14, wherein a flow rate greater than 1.5 cm3/min is used during filtration of the coating material through said membrane.

17. A method according to claim 1, wherein the coating material comes into contact with the immobilised microparticles following passage through the pores of the membrane.

18. A method according to claim 17, wherein the flow of coating material through the membrane is by means of gravity.

19. A method according to claim 17, wherein the flow of coating material through the membrane is by means of an electric field.

20. A method according to claim 17, wherein the flow of coating material through the membrane is by means of a magnetic field.

21. A method according to claim 17, wherein the mean diameter of the immobilised microparticles exceeds the membrane pore diameter so as to restrict the number of pores in direct contact therewith.

22. A method according to claim 1, wherein the coated immobilised microparticles are contacted with a solution of a bi-functional molecule which can bind to said coating material so that a number of layers of coating material can be built up on the immobilised microparticles retained on said membrane.

23. A method according to claim 1, wherein the coated microparticles are removed from the membrane by sonication.

24. A method according to claim 1, wherein the coated microparticles are removed from the membrane by dissolution of the membrane.

25. An anisotropically, biologically modified patterned microparticle.

26. An anisotropically, biologically modified patterned nanoparticle.

27. An anisotropically, biologically modified patterned nanosphere.

28. A nanostructure assembled on an anisotropically, biologically modified patterned particle according to claim 25.

29. A nanostructure according to claim 28, wherein the nanostructure is a nanowire.

30-32. (canceled)
